(19) United States
(12) Patent Application Publication
(10) Pub. No.: US 2018/0143785 A1
(43) Pub. Date: May 24, 2018

(54) SERVER SYSTEM AND READING METHOD

(71) Applicants: Inventec (Pudong) Technology Corporation, Shanghai (CN); INVENTEC CORPORATION, Taipei City (TW)

(72) Inventor: Wei-Guo ZHAO, SHANGHAI (CN)

(21) Appl. No.: 15/630,907

(22) Filed: Jun. 22, 2017

(30) Foreign Application Priority Data
Nov. 24, 2016 (CN) 201611056098.8

(51) Int. Cl. G06F 3/06; H04L 29/08

(52) U.S. Cl. CPC G06F 3/0659; H04L 29/08828

(57) ABSTRACT

A server system includes an expander unit and a baseboard management controller (BMC). The expander unit is electrically connected to a hard-disk unit, and configured to transmit a command signal to the hard-disk unit to read hard-disk information of the hard-disk unit. The baseboard management controller (BMC) is electrically connected to the expander unit, and configured to store the hard-disk information. After the hard-disk unit receives the command signal, the hard-disk unit generates a data signal according to the command signal and a state of the hard-disk unit, and transmits the data signal to the expander unit, so as to generate the hard-disk information according to the data signal.

### RELATED APPLICATIONS

This application claims priority to Chinese Application Serial Number 201611056098.8, filed Nov. 24, 2016, which is herein incorporated by reference.

### BACKGROUND

### Field of Invention

The present disclosure relates to a data processing system and a data processing method. More particularly, the present disclosure relates to a server system and a reading method.

### Description of Related Art

With the rapid development of data storage technology, a storage device with high storage capacity is widely applied to various kinds of electronic devices and electric systems. For example, when storage capacity of a storage device is dramatically increased, the amount of data stored and processed by a server system can be effectively increased accordingly. However, the number of storage devices supported by a current server system is limited to a current technical reading manner. The current technical reading manner is to store hard-disk information transmitted back from an onboard serial advanced technology attachment (SATA) interface into a baseboard management controller (BMC) via a basic input/output system (BIOS). However, when a onboard serial advanced technology attachment interface can merely support the limited number of hard-disk units, the number of the hard-disk units supported by a server system is significantly limited accordingly. Additionally, a manner of obtaining hard-disk information by cooperation among a basic input/output system, an onboard serial advanced technology attachment interface and a baseboard management controller is also ineffective, so that operating efficiency of a server system is decreased.

Accordingly, a significant challenge is related to ways in which to extend functions that a server system supports a hard-disk unit while at the same time enhancing operating efficiency of the server system associated with designing server systems and reading methods.

### SUMMARY

An aspect of the present disclosure is directed to a server system. The server system includes an expander unit and a baseboard management controller (BMC). The expander unit is electrically connected to a hard-disk unit, and configured to transmit a command signal to the hard-disk unit to read hard-disk information of the hard-disk unit. The baseboard management controller is electrically connected to the expander unit, and configured to store the hard-disk information. After the hard-disk unit receives the command signal, the hard-disk unit generates a data signal according to the command signal and a state of the hard-disk unit, and transmits the data signal to the expander unit, so as to generate the hard-disk information according to the data signal.

Another aspect of the present disclosure is directed to a reading method applied to a server system. The server system includes an expander unit and a baseboard management controller. The expander unit is electrically connected to a hard-disk unit, and the baseboard management controller is electrically connected to the expander unit. The reading method includes steps as follows: transmitting a command signal to the hard-disk unit via the expander unit; generating a data signal according to the command signal and a state of the hard-disk unit via the hard-disk unit; and transmitting the data signal to the expander unit, so as to generate a hard-disk information according to the data signal and store the hard-disk information into the baseboard management controller.

Again another aspect of the present disclosure is directed to a reading method applied to a server system. The server system includes a first expander unit, a second expander unit and a baseboard management controller. The first expander unit is electrically connected to a first hard-disk unit, the second expander unit is electrically connected to the first expander unit and a second hard-disk unit, and the baseboard management controller is electrically connected to the first expander unit. The reading method includes steps as follows: transmitting a first command signal to the first hard-disk unit via the first expander unit, and transmitting a second command signal to the second hard-disk unit via the second expander unit; generating a first data signal according to the first command signal and a state of the first hard-disk unit via the first hard-disk unit, and generating a second data signal according to the second command signal and a state of the second hard-disk unit via the second hard-disk unit; generating a first hard-disk information according to the first data signal, and generating a second hard-disk information according to the second data signal; and transmitting the first hard-disk information and the second hard-disk information to the first expander unit, so as to generate a hard-disk information according to the first hard-disk information and the second hard-disk information and store the hard-disk information into the baseboard management controller.

It is to be understood that the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block schematic diagram of a server system according to embodiments of the present disclosure;

FIG. 2 is a block schematic diagram of a server system according to embodiments of the present disclosure;

FIG. 3 is a flow chart of a reading method according to embodiments of the present disclosure; and

FIG. 4 is a flow chart of a reading method according to embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

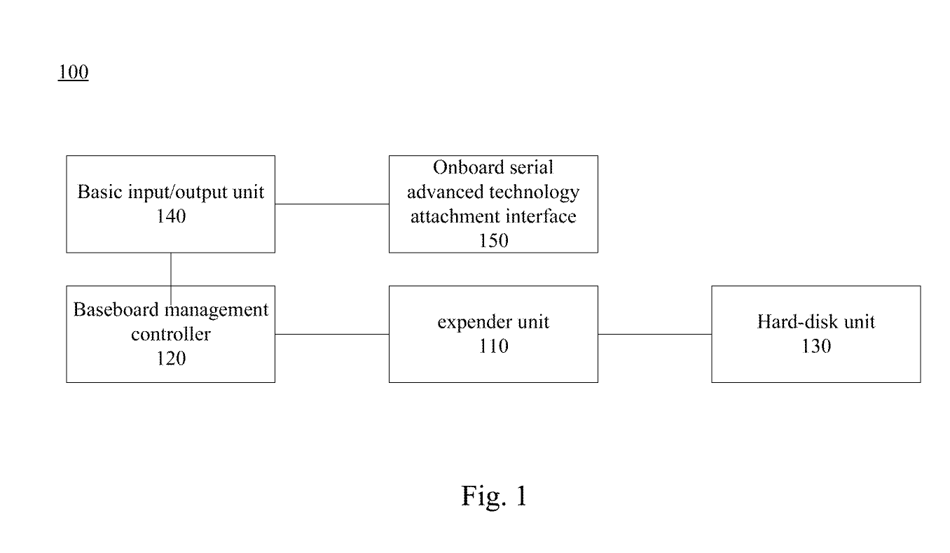

FIG. 1 is a block schematic diagram of a server system 100 according to embodiments of the present disclosure. As shown in FIG. 1, the server system 100 includes an expander unit 110 and a baseboard management controller 120. The expander unit 110 is electrically connected to a hard-disk unit 130, and the baseboard management controller 120 is electrically connected to the expander unit 110. The expander unit 110 is configured to transmit a command signal to the hard-disk unit 130 to read hard-disk information of the hard-disk unit 130. The baseboard management controller 120 is configured to store the hard-disk information.

In one embodiment, after the hard-disk unit 130 receives the command signal, the hard-disk unit 130 generates a data signal according to the command signal and a state of the hard-disk unit 130, and transmits the data signal to the expander unit 110, so as to generate the hard-disk information according to the data signal. For example, the expander unit 110 can check an electrical connection between the expander unit 110 and the hard-disk unit 130 by the command signal. When the expander unit 110 is electrically connected to the hard-disk unit 130, the expander unit 110 can command the hard-disk unit 130 to transmit the data signal back, so as to check the state of the hard-disk unit 130. In another embodiment, after the expander unit 110 receives the data signal, the expander unit 110 determines a storage form of the hard-disk unit 130 according to the data signal. For example, the storage form of the hard-disk unit 130 can support a serial advanced technology attachment (SATA) interface, a small computer system interface (SCSI) or any interface which can be configured to support data transmission to store data.

In further embodiment, after the expander unit 110 receives the data signal, and the storage form of the hard-disk unit 130 is determined, the expander unit 110 calculates a storage state of the hard-disk unit 130 according to the data signal and the storage form of the hard-disk unit 130, so as to generate the hard-disk information. For example, the hard-disk information can represent total storage capacity of the hard-disk unit 130 of the server system 100. When the storage form of the hard-disk unit 130 supports an onboard serial advanced technology attachment interface, the expander unit 110 obtains user addressable logical sectors of the hard-disk unit 130 according to the data signal, and calculates the total storage capacity of the hard-disk unit 130 according to the user addressable logical sectors of the hard-disk unit 130 and storage capacity corresponding to each of the user addressable logical sectors, so as to generate the hard-disk information; when the storage form of the hard-disk unit 130 supports a small computer system interface, the expander unit 110 obtains logical block addressing (LBA) of the hard-disk unit 130 according to the data signal, and calculates the total storage capacity of the hard-disk unit 130 according to the logical block addressing of the hard-disk unit 130 and a block length in byte corresponding to each of the logical block addressing, so as to generate the hard-disk information. It should be noted that, the embodiments mentioned above are used for illustrating some possible manners of calculating the storage state of the hard-disk unit 130 and some possible manners of representing the hard-disk information, and the present disclosure is not limited thereto.

In one embodiment, the server system 100 further includes a basic input/output unit 140 and an onboard serial advanced technology attachment interface 150. The basic input/output unit 140 is electrically connected to the baseboard management controller 120, and the onboard serial advanced technology attachment interface 150 is electrically connected to the basic input/output unit 140. The basic input/output unit 140 is configured to control the server system 100 according to an operating system. The onboard serial advanced technology attachment interface 150 is configured to connect the basic input/output unit 140 with an onboard serial advanced technology attachment device. For example, the onboard serial advanced technology attachment device can be a storage device, and a storage form of such storage device supports an onboard serial advanced technology attachment interface, thus the basic input/output unit 140 can store the hard-disk information of the storage device transmitted back from the onboard serial advanced technology attachment interface 150 into the baseboard management controller 120.

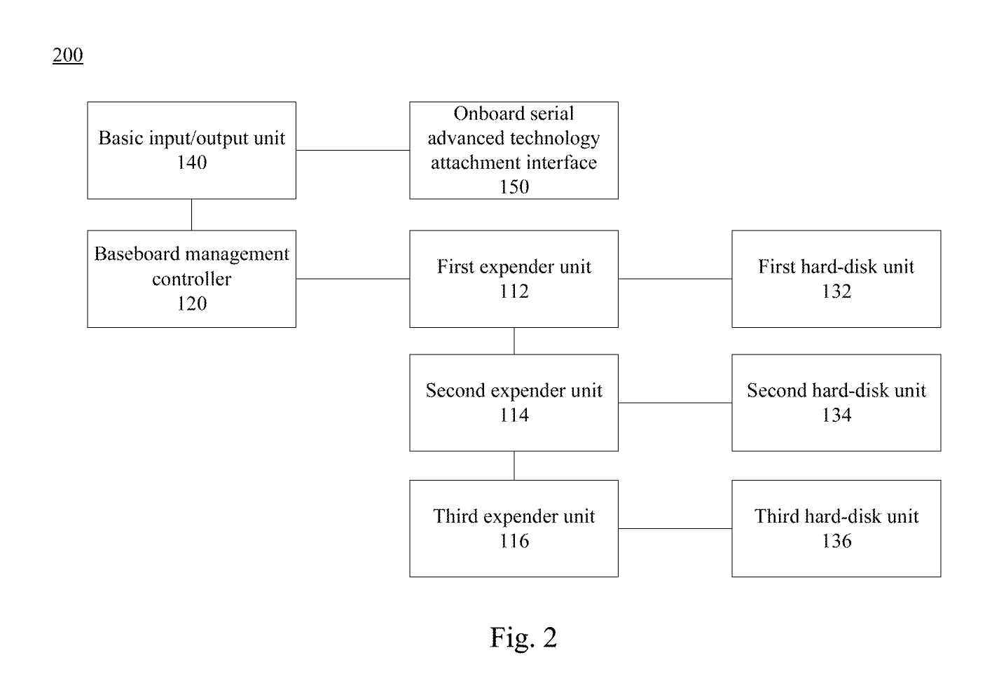

FIG. 2 is a block schematic diagram of a server system 200 according to embodiments of the present disclosure. As shown in FIG. 2, the server system 200 includes a first expander unit 112, a second expander unit 114 and the baseboard management controller 120. The first expander unit 112 is electrically connected to the baseboard management controller 120 and a first hard-disk unit 132, and the second expander unit 114 is electrically connected to the first expander unit 112 and a second hard-disk unit 134. The first expander unit 112 is configured to transmit a first command signal to the first hard-disk unit 132 to read hard-disk information of the first hard-disk unit 132. The second expander unit 114 is configured to transmit a second command signal to the second hard-disk unit 134 to read hard-disk information of the second hard-disk unit 134.

In one embodiment, after the first hard-disk unit 112 generates a first data signal according to the first command signal and a state of the first hard-disk unit 132, the first hard-disk unit 132 transmits the first data signal to the first expander unit 112, so as to generate first hard-disk information according to the first data signal. Similarly, after the second hard-disk unit 134 generates s second data signal according to the second command signal and a state of the second hard-disk unit 134, the second hard-disk unit 134 transmits the second data signal to the second expander unit 114, so as to generate second hard-disk information according to the second data signal and transmit the second hard-disk information to the first expander unit 112.

In another embodiment, the first expander unit 112 can determine a storage form of the first hard-disk unit 132 according to the first data signal. Similarly, the second expander unit 114 can determine a storage form of the second hard-disk unit 134 according to the second data signal. For example, the storage form of the first hard-disk unit 132 and the second hard-disk unit 134 can support a serial advanced technology attachment interface, a small computer system interface (SCSI) or any interface which can be configured to support data transmission to store data, and the storage form of the first hard-disk unit 132 can be different from that of the second hard-disk unit 134.

In further embodiment, the first expander unit 112 can calculate a storage state of the first hard-disk unit 132 according to the first data signal and the storage form of the first hard-disk unit 132, so as to generate the first hard-disk information. Similarly, the second expander unit 114 can calculate a storage state of the second hard-disk unit 134 according to the first data signal and the storage form of the second hard-disk unit 134, so as to generate the second hard-disk information. Possible manners of calculating the storage states of the first hard-disk unit 132 and the second hard-disk unit 134 and possible manners of representing the first hard-disk information and the second hard-disk information are illustrated by the embodiments mentioned above in detail, so these will not be repeated.

In further embodiment, the first expander unit 112 generates the hard-disk information according to the first hard-disk information and the second hard-disk information. For example, the first hard-disk information and the second hard-disk information can respectively represent total storage capacity of the first hard-disk unit 132 and the second hard-disk unit 134, and the hard-disk information can represent total storage capacity of the server system 200. After the first expander unit 112 receives the second hard-disk information transmitted from the second expander unit 114, the first expander unit 112 can sum up the total storage capacity of the first hard-disk unit 132 and the second hard-disk unit 134 to calculate the total storage capacity of the server system 200, so as to generate the hard-disk information.

In one embodiment, the server system 200 further includes a third expander unit 116, and the third expander unit 116 is electrically connected to the second expander unit 114 and a third hard-disk unit 136. The third expander unit 116 is configured to transmit a third command signal to the third hard-disk unit 136 to read hard-disk information of the third hard-disk unit 136. After the third hard-disk unit 136 generate a third data signal according to the third command signal and a state of the third hard-disk unit 136, the third hard-disk unit 136 transmits the third data signal to the third expander unit 116, so as to generate third hard-disk information according to the third data signal and transmit the third hard-disk information to the second expander unit 114.

In another embodiment, the third hard-disk information can represent total storage capacity of the third hard-disk unit 136. Accordingly, after the second expander unit 114 receives the third hard-disk information transmitted from the third expander unit 116, the second expander unit 114 can sum up the total storage capacity of the second hard-disk unit 134 and the third hard-disk unit 136, and transmit the summation result to the first expander unit 112 to generate the hard-disk information. It should be noted that, the embodiments mentioned above are used for illustrating some possible manners of calculating the hard-disk information, and the present disclosure is not limited thereto. For example, after the second expander unit 114 receives the third hard-disk information transmitted from the third expander unit 116, the second expander unit 114 can transmit the total storage capacity of the second hard-disk unit 134 and the third hard-disk unit 136 to the first expander unit 112, thus the first expander unit 112 can sum up the total storage capacity of the first hard-disk unit 132, the second hard-disk unit 134 and the third hard-disk unit 136, so as to generate the hard-disk information.

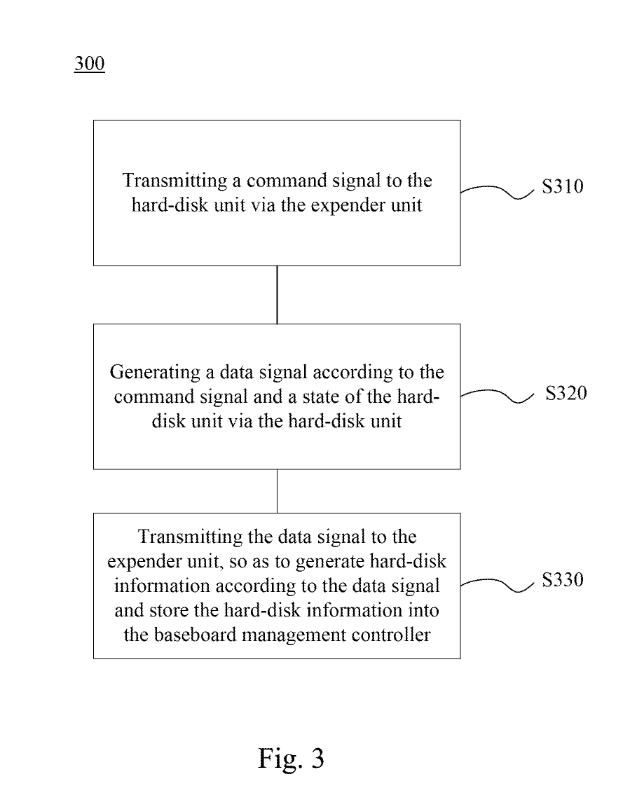

FIG. 3 is a flow chart of a reading method 300 according to embodiments of the present disclosure. In one embodiment, the reading method 300 can be applied to the server system 100, but the present disclosure is not limited thereto. For facilitating of understanding the reading method 300, the server system 100 is used as an example for illustrating the reading method 300 as follows. As shown in FIG. 3, the reading method 300 includes steps as follows:
S310: transmitting a command signal to the hard-disk unit 130 via the expander unit 110;
S320: generating a data signal according to the command signal and a state of the hard-disk unit 130 via the hard-disk unit 130; and
S330: transmitting the data signal to the expander unit 110, so as to generate hard-disk information according to the data signal and store the hard-disk information into the baseboard management controller 120.

For example, reference is now made to the step S310 and the step S320. The expander unit 110 can check an electrical connection between the expander unit 110 and the hard-disk unit 130 by the command signal. When the expander unit 110 is electrically connected to the hard-disk unit 130, the expander unit 110 can command the hard-disk unit 130 to transmit the data signal back, so as to check a state of the hard-disk unit 130.

In one embodiment, reference is now made to the step S330. After the expander unit 110 receives the data signal, it is determining a storage form of the hard-disk unit 130 according to the data signal via the expander unit 110. For example, the storage form of the hard-disk unit 130 can support a serial advanced technology attachment interface, a small computer system interface or any interface which can be configured to support data transmission to store data.

In another embodiment, reference is still made to the step S330. After the storage form of the hard-disk unit 130 is determined, it is calculating a storage state of the hard-disk unit 130 according to the data signal and the storage form of the hard-disk unit 130 via the expander unit 110, so as to generate the hard-disk information. For example, the hard-disk information can represent total storage capacity of the hard-disk unit 130 of the server system 100. Possible manners of calculating the storage state of the hard-disk unit 130 and possible manners of representing the hard-disk information are illustrated by the embodiments mentioned above in detail, so these will not be repeated.

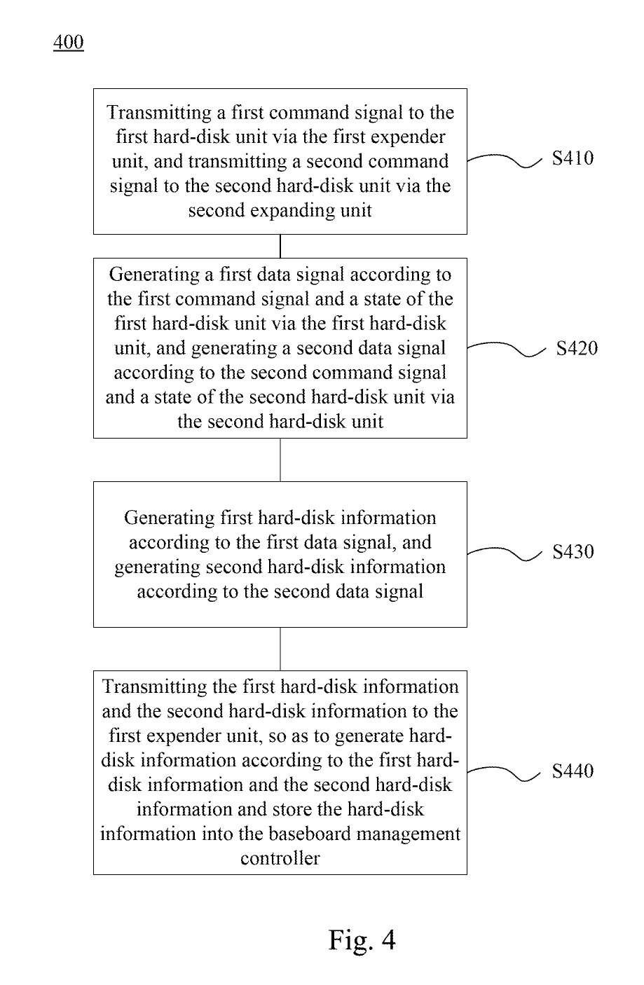

FIG. 4 is a flow chart of a reading method 400 according to embodiments of the present disclosure. In one embodiment, the reading method 400 can be applied to the server system 200, but the present disclosure is not limited thereto. For facilitating of understanding the reading method 400, the server system 200 is used as an example for illustrating the reading method 400 as follows. As shown in FIG. 4, the reading method 400 includes steps as follows:
S410: transmitting a first command signal to the first hard-disk unit 132 via the first expander unit 112, transmitting a second command signal to the second hard-disk unit 134 via the second expander unit 114;
S420: generating a first data signal according to the first command signal and a state of the first hard-disk unit 132 via the first hard-disk unit 132, and generating a second data signal according to the second command signal and a state of the second hard-disk unit 134 via the second hard-disk unit 134;
S430: generating first hard-disk information according to the first data signal, and generating second hard-disk information according to the second data signal; and
S440: transmitting the first hard-disk information and the second hard-disk information to the first expander unit 112, so as to generate hard-disk information according to the first hard-disk information and the second hard-disk information and store the hard-disk information into the baseboard management controller 120.

In one embodiment, reference is now made to the step S430. When the first expander unit 112 receives the first data signal, it is determining a storage form of the first hard-disk unit 132 according to the first data signal via the first expander unit 112. Similarly, when the second expander unit 114 receives the second data signal, it is determining a storage form of the second hard-disk unit 134 according to the second data signal via the second expander unit 114. For example, the storage form of the first hard-disk unit 132 and the second hard-disk unit 134 can support a serial advanced technology attachment interface, a small computer system interface or any interface which can be configured to support data transmission to store data, and the storage form of the first hard-disk unit 132 can be different from that of the second hard-disk unit 134.

In another embodiment, reference is still made to the step S430. After the storage form of the first hard-disk unit 132 is determined, it is calculating a storage state of the first hard-disk unit 132 according to the first data signal and the storage form of the first hard-disk unit 132 via the first expander unit 112, so as to generate the first hard-disk information. Similarly, after the storage form of the second hard-disk unit 134 is determined, it is calculating a storage state of the second hard-disk unit 134 according to the second data signal and the storage form of the second hard-disk unit 134 via the second expander unit 114, so as to generate the second hard-disk information. Possible manners of calculating the storage states of the first hard-disk unit 132 and the second hard-disk unit 134 and possible manners of representing the first hard-disk information and the second hard-disk information are illustrated by the embodiments mentioned above in detail, so these will not be repeated.

In further embodiment, reference is now made to the step S440, the first hard-disk information and the second hard-disk information can respectively represent total storage capacity of the first hard-disk unit 132 of the second hard-disk unit 134, and the hard-disk information can represent total storage capacity of the server system 200. After the first expander unit 112 receives the second hard-disk information transmitted from the second expander unit 114, the total storage capacity of the first hard-disk unit 132 and the second hard-disk unit 134 can be summed up to calculate the total storage capacity of the server system 200 via the first expander unit 112, so as to generate the hard-disk information.

In the embodiments mentioned above, the server system and the reading method of the present disclosure adopts the command signal to command the hard-disk unit via the expander unit, so that the hard-disk unit generates the data signal according to the state of the hard-disk unit. Subsequently, the expander unit generates the hard-disk information according to the data signal, and stores the hard-disk information into the baseboard management controller. Accordingly, the server system and the reading method of the present disclosure can obtain and store the hard-disk information by direct cooperation between the expander unit and the baseboard management controller, so as to avoid dramatic adjustment for the onboard serial advanced technology attachment interface of the server system. Accordingly, it is not only extending functions that the server system supports the hard-disk unit, but also enhancing operating efficiency of the server system. Therefore, not only functions that the server system supports the hard-disk unit can be effectively extended, but operating efficiency of the server system can also be enhanced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present invention cover modifications and variations of this present disclosure provided they fall within the scope of the following claims.

What is claimed is:

1. A server system, comprising:
an expander unit, electrically connected to a hard-disk unit, and configured to transmit a command signal to the hard-disk unit to read hard-disk information of the hard-disk unit;
a baseboard management controller (BMC), electrically connected to the expander unit, and configured to store the hard-disk information,
wherein after the hard-disk unit receives the command signal, the hard-disk unit generates a data signal according to the command signal and a state of the hard-disk unit, and transmits the data signal to the expander unit, so as to generate the hard-disk information according to the data signal.

2. The server system of claim 1, wherein after the expander unit receives the data signal, the expander unit determines a storage form of the hard-disk unit according to the data signal.

3. The server system of claim 2, wherein after the expander unit receives the data signal, and the storage form of the hard-disk unit is determined, the expander unit calculates a storage state of the hard-disk unit according to the data signal and the storage form of the hard-disk unit, so as to generate the hard-disk information.

4. The server system of claim 1, further comprising:
a basic input/output unit, electrically connected to the baseboard management controller, and configured to control the server system according to an operating system; and
an onboard serial advanced technology attachment (SATA) interface, electrically connected to the basic input/output unit, and configured to connect the basic input/output unit with an onboard serial advanced technology attachment device.

5. The server system of claim 1, wherein the expander unit comprises a plurality of expander units, the hard-disk unit comprises a plurality of hard-disk units, the expander units comprise a first expander unit and a second expander unit, and the hard-disk units comprise a first hard-disk unit and a second hard-disk unit;
wherein the first expander unit is electrically connected to the baseboard management controller and the first hard-disk, and configured to transmit a first command signal to the first hard-disk unit to read hard-disk information of the first hard-disk unit; the second expander unit is electrically connected to the first expander unit and the second hard-disk unit, and configured to transmit a second command signal to the second hard-disk unit to read hard-disk information of the second hard-disk unit.

6. The server system of claim 5, wherein after the second hard-disk unit generates a second data signal according to the second command signal and a state of the second hard-disk unit, the second hard-disk unit transmits the second data signal to the second expander unit, so as to generate second hard-disk information according to the second data signal and transmit the second hard-disk information to the first expander unit.

7. The server system of claim 6, wherein after the first hard-disk generates a first data signal according to the first command signal and a state of the first hard-disk unit, the first hard-disk unit transmits the first data signal to the first expander unit, so as to generate first hard-disk information according to the first data signal, wherein the first expander unit generates the hard-disk information according to the first hard-disk information and the second hard-disk information.

8. A reading method, applied to a server system, wherein the server system comprises an expander unit and a baseboard management controller, the expander unit is electrically connected to a hard-disk unit, and the baseboard management controller is electrically connected to the expander unit, wherein the reading method comprises:
transmitting a command signal to the hard-disk unit via the expander unit;
generating a data signal according to the command signal and a state of the hard-disk unit via the hard-disk unit; and
transmitting the data signal to the expander unit, so as to generate hard-disk information according to the data signal and store the hard-disk information into the baseboard management controller.

9. The reading method of claim 8, wherein transmitting the data signal to the expander unit, so as to generate the hard-disk information according to the data signal comprises:
determining a storage form of the hard-disk unit according to the data signal, and calculating a storage state of the hard-disk unit, so as to generate the hard-disk information.

10. A reading method, applied to a server system, wherein the server system comprises a first expander unit, a second expander unit and a baseboard management controller, the first expander unit is electrically connected to a first hard-disk unit, the second expander unit is electrically connected to the first expander unit and a second hard-disk unit, and the baseboard management controller is electrically connected to the first expander unit, wherein the reading method comprises:
transmitting a first command signal to the first hard-disk unit via the first expander unit, and transmitting a second command signal to the second hard-disk unit via the second expander unit;
generating a first data signal according to the first command signal and a state of the first hard-disk unit via the first hard-disk unit, and generating a second data signal according to the second command signal and a state of the second hard-disk unit via the second hard-disk unit;
generating first hard-disk information according to the first data signal, and generating second hard-disk information according to the second data signal; and
transmitting the first hard-disk information and the second hard-disk information to the first expander unit, so as to generate hard-disk information according to the first hard-disk information and the second hard-disk information and store the hard-disk information into the baseboard management controller.
